(19) United States
(12) Patent Application Publication
(10) Pub. No.: US 2023/0025124 A1
(43) Pub. Date: Jan. 26, 2023

(54) RECIRCULATION FLUID EJECTION DEVICE

(71) Applicant: Hewlett-Packard Development Company, L.P., Spring, TX (US)

(72) Inventors: Jacob Lum, Corvallis, OR (US); James A Feinn, San Diego, CA (US); Mengqian Lu, San Diego, CA (US)

(73) Assignee: Hewlett-Packard Development Company, L.P., Spring, TX (US)

(21) Appl. No.: 17/781,535

(22) PCT Filed: Dec. 6, 2019
(86) PCT No.: PCT/US2019/064838

§ 371 Date: Jun. 1, 2022

(51) Int. Cl. B41J 2/18; B41J 2/175

(52) U.S. Cl. CPC B41J 2/18; B41J 2/17596

(57) ABSTRACT

An example recirculation fluid ejection device includes a first unit droplet generator including a first actuator and a first nozzle between a first and a second fluid feed hole, the first fluid feed hole located on a first channel and the second fluid feed hole and a first pump located on a second channel. The example device includes a second unit droplet generator including a second actuator and a second nozzle between a third and a fourth fluid feed hole, the third feed hole located on a third channel and the fourth fluid feed hole and a second pump located on a fourth channel. The first and the second actuators eject fluid at substantially the same backpressure. A first pressure measurable at an inlet of the first channel and the third channel are different from a second pressure measurable at an outlet of the second channel and the fourth channel.

### BACKGROUND

Fluid ejection systems may operate by ejecting a fluid from nozzles to form images on media and/or forming three-dimensional objects, for example. In some fluid ejection systems, fluid feed holes lead fluid into fluid ejection chambers, and the fluid is expelled from nozzles of a fluid ejection device (also known as a fluid ejection die). The fluid may bond to a surface of a medium and form graphics, text, images, and/or objects.

### BRIEF DESCRIPTION OF THE DRAWINGS

FIGS. 1A-1C are diagrams of example recirculation fluid ejection unit droplet generators 102, according to the present disclosure.

FIG. 2 is a diagram of an example recirculation fluid ejection device including unit droplet generators, according to the present disclosure.

FIG. 3 is another diagram of an example recirculation fluid ejection device including unit droplet generators, according to the present disclosure.

FIG. 4 is a diagram of an example recirculation fluid ejection device having manifolded unit droplet generators according to the present disclosure.

FIG. 5 is a diagram of an example recirculation fluid ejection device including an asymmetrical unit droplet generator arrangement according to the present disclosure.

### DETAILED DESCRIPTION

Fluid ejection devices may deposit fluids onto media (e.g., a print medium) through a fluid feed hole(s) and a nozzle. For instance, a nozzle can include an opening in a thin film portion of a fluid ejection device, and a fluid feed hole can include a portion of the fluid ejection device through which the fluid passes before reaching the nozzle and the media.

Recirculation fluid ejection systems can circulate and recirculate fluid between a fluid supply and its associated fluid ejection device. These systems can circulate fluid through the fluid ejection device and return it to the fluid supply (e.g., a fluid supply reservoir). Recirculation can be utilized to carry away and filter out particles or air bubbles introduced by nozzles, which may keep solids of some fluids suspending while keeping fluid temperature and viscosity substantially uniform. As used herein, “substantially” means that a characteristic (e.g., uniformity, backpressure, consistency, etc.) need not be absolute, but is close enough to the absolute characteristic so as to achieve the desired effects of the characteristic. Recirculation fluid ejection systems can be used when particular fluids (e.g., fluids used in industrial print markets, industrial print media, etc.) are used that may not perform as desired in non-recirculation fluid ejection systems.

The recirculating fluid flow can create a thermal and/or pressure gradient across an array of nozzles of a recirculation fluid ejection system. As used herein, recirculating fluid flow includes circulating and/or recirculating fluid flow. For instance, examples are not limited to recirculating fluid through a fluid ejection device. Thermal gradients can induce fluid viscosity/surface tension gradients and backpressure gradients can cause differences in refill speed and menisci positions across an array of nozzles of the fluid ejection system. These may cause undesirable results. For instance, the recirculation system can include channels (e.g., silicon channels) having different pressures. Pressure differences between the channels and fluid feed holes of associated unit droplet generators can create print defects related to fluid drop shape formation and/or fluid drop tail breakoff. These print defects may result in undesirable print job results.

In contrast, some examples of the present disclosure include an arrangement of unit droplet generators having actuators ejecting fluid from the nozzles at substantially the same backpressure to recirculate fluid through channels of a recirculation fluid ejection device. For instance, fluid can flow through unit droplet generators (e.g., in a first fluid hole, through a nozzle, out a second fluid feed hole) in a substantially consistent pressure gradient direction across unit droplet generators of a recirculation fluid ejection device. For example, fluid can flow through unit droplet generators from channels having higher pressures to channels having lower pressure (or vice versa). This allows for the actuators to eject fluid from the nozzles at substantially the same backpressure, resulting in reduced variations in drop ejection and nozzle refill that may otherwise correspond to visible print defects or limitations in recirculation operating points (e.g., drop trajectory errors, refill limitations, nozzle depriming limitations, etc.). For instance, because the actuators all eject fluid from the nozzles (e.g., fire) at a substantially same backpressure, inertial droplet and tail breakoff can be substantially the same across the recirculation fluid ejection device.

In some examples, a chevron pattern (e.g., arrangement, path flow, etc.) of the unit droplet generators can be used to blend extremes of thermal and pressure gradients. For instance, the chevron pattern can be used to reduce visible print defects on the media that are related to drop weight and shape differences that may be caused by differences in fluid temperature or pressure in the firing chamber. By using a chevron pattern, an overlapping region of the fluid ejection device that is both cooler and warmer can be increased. In this manner, moderate pressures and temperatures can be overlapped and the extremes of pressures and temperatures on the fluid ejection device can be overlapped to average out a drop weight and shape variation. This may reduce a severity of any visible banding that may appear due to drop weight and shape variation on a printed media.

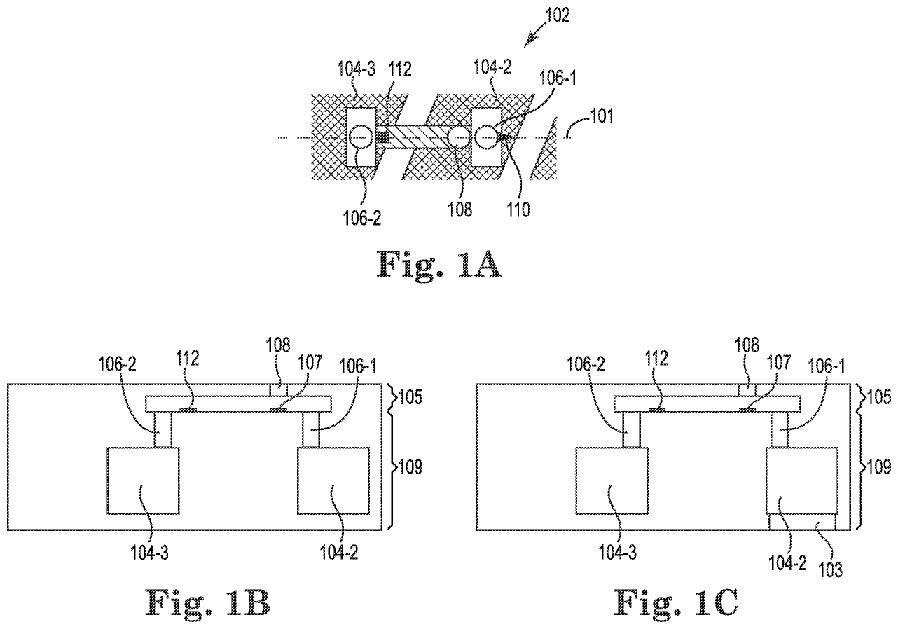

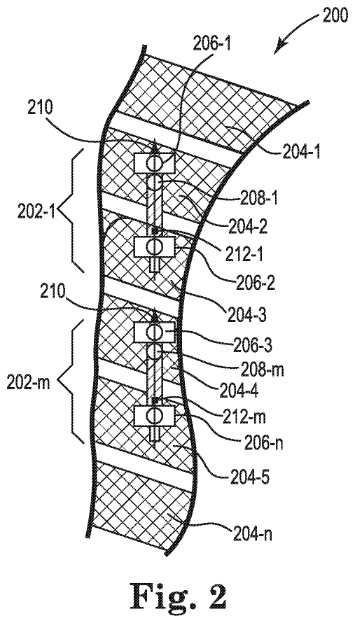

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 208 in FIG. 2. Multiple analogous elements within one figure may be referenced with a reference numeral followed by a hyphen and another numeral or a letter. For example, 106-1 may reference element 06-1 in FIG. 1 and 106-2 may reference element 06-2, which can be analogous to element 06-1. Such analogous elements may be generally referenced without the hyphen and extra numeral or letter. For example, elements 106-1 and 106-2 may be generally referenced as 106.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. As used herein, the designator “M”, “N”, “R”, and “T” particularly with respect to reference numerals in the drawings, indicates that a number of the particular feature so designated can be included with examples of the present disclosure. The designators can represent the same or different numbers of the particular features.

FIGS. 1A-1C are diagrams of example recirculation fluid ejection unit droplet generators 102, according to the present disclosure. As used herein, a unit droplet generator can include components for providing and generating fluid droplets. The components, for instance, can include an inertial micro recirculation pump (e.g., for on-demand recirculation and meniscus agitation), a fluid restrictor (e.g., for confining thermal ink jet (TIJ) drive bubble and dampening fluid refill, a resistor (e.g., thermal ink jet resister), a nozzle, and fluid feed hole(s). The unit droplet generator 102 may be considered a “unit” because it includes elements (e.g., fluid feed holes 106, a nozzle 108, an actuator 107, and a pump 112) of a firing chamber enclosure that are not shared with another resistor; there is a single resistor for the layer including the unit droplet generator 102.

FIG. 1A is a top view of the unit droplet generator 102, while FIGS. 1B and 1C are cross-sectional views of the unit droplet generator 102 taken at line 101. In some examples, the unit droplet generator includes the elements of photo resist layer 105, as well as the fluid feed holes 106. For instance, the unit droplet generator 102 includes fluid feed holes 106-1 and 106-2, a nozzle 108, and a pump 112. Portions of the unit droplet generator 102 can be located on channels 104-2, 104-3 of a fluid ejection device. As used herein, a component or portion located “on” a channel may be located above the channel such that the component may not directly touch the channel. While singular fluid feed holes 106 are illustrated at each end of the unit droplet generator 102, more than one fluid feed hole may be present at one or both ends.

FIG. 1B illustrates a cross-sectional view of the unit droplet generator 102 without a channel inlet/outlet, while FIG. 1C illustrates a cross-sectional view of the unit droplet generator 102 with a channel inlet/outlet 103. The channels 104 can sit below the unit droplet generator 102, for instance in a fluidic layer (e.g., fluidic silicon layer) 109, that may include the fluid feed holes 106. A fluidic photoresist layer 105 above the fluidic layer 109 can include the actuator 107, nozzle 108, and pump 112.

The nozzle 108 is located between the fluid feed hole 106-1 (e.g., located on a channel 104-3) and the pump 112 and the fluid feed hole 106-2 (e.g., located on a channel 104-3). The pump 112 moves fluid within the unit droplet generator 102, and the actuator 107 controls accessibility of the nozzle 108. For instance, the actuator 107 can eject fluid (e.g., droplets) on demand from the nozzle 108 allowing fluid to flow out of the nozzle 108 during operation.

Fluid can enter one side of a channel, for instance channel 104-2 at channel inlet/outlet 103 and leave from another side of channel 104-2 with a pressure gradient determining a flow of the fluid. As the fluid enters a channel 104, it passes each unit droplet generator 102 of a recirculation fluid ejection device 100 allowing fluid into fluid feed holes 106 of the unit droplet generator 102.

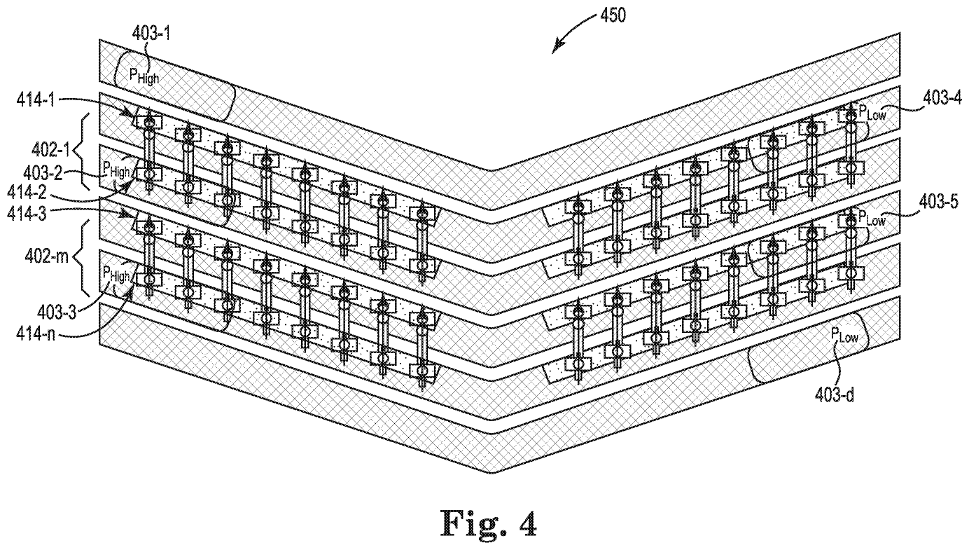

FIG. 2 is a diagram of an example recirculation fluid ejection device 200 including unit droplet generators 202, according to the present disclosure. While illustrated as individual unit droplet generators in FIG. 2, unit droplet generators 202 can be manifolded such that fluid feed holes 206 (e.g., inlets and outlets) can be coupled together in a layer as discussed further herein with respect to FIG. 4. While two unit droplet generators 202-1, 202-m are illustrated in FIG. 2, more unit droplet generators may be present in fluid ejection device 200. For instance, additional unit droplet generators may be located along channels 204-1 and 204-2 and along channels 204-3 and 204-n.

The recirculation fluid ejection device 200 can include a unit droplet generator 202-1 and a unit droplet generator 202-m, each of which spans two channels 204-2 and 204-3 and 204-4 and 204-5, respectively (e.g., silicon channels). The channels 204 can sit below the unit droplet generators 202. Fluid can enter one side of a channel 204 and leave from another side with a pressure gradient determining a flow of the fluid. As the fluid enters a channel 204, it passes each unit droplet generator 202 of the recirculation fluid ejection device 200 allowing fluid into fluid feed holes 206 of the unit droplet generators 202.

In some examples, the unit droplet generator 202-1 includes a nozzle 208-1 between a fluid feed hole 206-1 located on a channel 204-2 and a fluid feed hole 206-2 and a pump 212-1 (e.g., a micro-resistor pump, inertial micro pump, etc.) located on a channel 204-3. The unit droplet generator 202-m includes a nozzle 208-2 between a fluid feed hole 206-3 located on a channel 204-4 and a fluid feed hole 206-n and a pump 212-m located on a channel 204-5. In examples in which the pumps 212 are inertial micro pumps, the pumps 212 can drive net inertial flow by creating an inertial flow difference across the pumps 212 during actuation. The unit droplet generators 202 can also include actuators (e.g., an actuator such as the actuator 107 illustrated in FIGS. 1B and 1C) below the nozzles 208, but not visible in the view illustrated in FIG. 2.

The channels 204 can have different pressures, for instance, the channel 204-2 can have a lower pressure as compared to the channel 204-3 (or vice versa), and the channel 204-4 can have a lower pressure as compared to the channel 204-5 (or vice versa). In some instances, the lower-pressure channels (e.g., channels 204-2 and 104-4) can have substantially the same pressure, and the higher-pressure channels (e.g., channels 104-3 and 104-5) can have substantially the same pressure. The channel pressure arrangement allows for a substantially consistent pressure gradient direction across the unit droplet generators 202. Put another way, in some examples, a pressure measurable at an inlet of the channel 204-3 and an inlet of the channel 204-5 is different from a pressure measurable at an outlet of the channel 204-2 and an outlet of the channel 204-4.

The recirculation flow can flow in a same direction across the unit droplet generators 202, such that an actuator (e.g., actuator 107 illustrated in FIGS. 1B and 1C) ejects fluid from the nozzle 208 at substantially the same backpressure to recirculate fluid through particular channels 204 and the nozzles 208. As used herein, the actuator ejecting fluid from the nozzles 208 at a same backpressure includes meniscus positions of the nozzles 208 being significantly consistent. A meniscus position refers to how much fluid is in a bore of a nozzle 208. The meniscus is the interface between the fluid volume in the bore and the atmosphere. A high meniscus position means higher levels of fluid in the bore, and a low meniscus position means lower levels of fluid in the bore. Pressure and fluid flow can affect the meniscus positions. Examples of the present disclosure include significantly parallel channels (e.g., in a chevron pattern) such that the backpressure in the channels is consistent resulting in consistent meniscus positions. Such consistent meniscus positions can result in improved print results (e.g., consistent and even ink release).

In some examples, fluid can recirculate through the unit droplet generators 202 in a high pressure-to-low pressure manner. In such an example, fluid can flow (e.g., with the aid of pumps 212) from fluid feed hole 206-2 towards nozzle 208-1 and from fluid feed hole 206-n towards nozzle 208-m as indicated by arrows 210. Doing so can allow for the actuator to eject fluid from nozzles 208 at substantially the same backpressure and can result in substantially uniform fluid droplet generation. In some examples, the recirculation fluid ejection device can receive a command to adjust the pressures of the channels 104. The command can indicate pressure designations to channels 204 based on a desired ejection backpressure.

In some examples, the nozzles 208 can be located nearer to a first one of the fluid feed holes 106 on the unit droplet generators 202. For instance, with respect to unit droplet generator 202-1, the nozzle 208-1 may be located nearer the fluid feed hole 206-1 than the fluid feed hole 206-2 and the pressure of the channel 204-2 may be lower than that of the channel 204-3 or the nozzle 208-1 may be located nearer the fluid feed hole 206-1 than the fluid feed hole 206-2 and the pressure of the channel 104-2 may be higher than that of the channel 104-3. The same can be true for unit droplet generator 202-m. Such an offset can allow for a nozzle to print at a higher frequency than if it was positioned equidistant from both fluid feed holes. This can result in faster printing. If fluid is flowing in the opposite direction, print speeds may be slower. In some examples, having a nozzle closer to one ink feed hole reserves space for a pump that uses inertial difference in a channel to operate. It may be desirable to keep such a pump further from the nozzle, so the pump does not become a fluid (e.g., droplet) ejector.

Such a unit droplet generator 202 architecture can allow for the actuators to eject fluid from the nozzles 208 at substantially the same backpressure and can result in substantially uniform fluid droplet generation. For instance, such an architecture can facilitate higher flux printing performance by including nozzles on the “upstream side” (e.g., closer to a higher-pressure channel) and/or allows for placement of a microcirculation pump on the end opposite the nozzle.

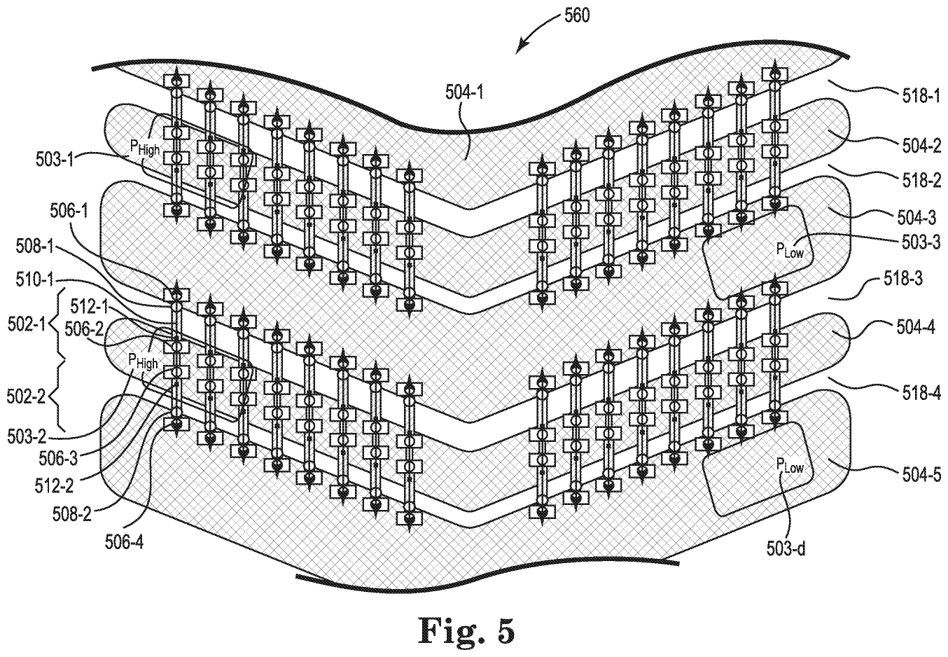

In some examples, the channel 204-3 can have a larger cross-sectional area than the channel 204-2 (or vice versa). The larger cross-sectional area may accommodate a plurality of fluid feed holes of a plurality of unit droplet generators, as will be discussed further herein with respect to FIG. 5. Additionally or alternatively, the larger cross-sectional area (e.g., channel 104-3) can accommodate higher flow as compared to a channel having a smaller cross-sectional area (e.g., the channel 104-2).

In some examples, fluids having a higher viscosity can create higher pressure drops through the channels 204, and a larger cross-sectional area can accommodate desired flow rates. For instance, a supply channel supplying fluid to the nozzles 208 can have a larger cross-sectional area than a return channel taking fluid away from the nozzles 208. In a high flux example, a larger amount of recirculation flux may be used as compared to a lower flux print job. In such an example, an increased amount of space may be desired to accommodate the recirculation flux plus the printing flux flowing to nozzles on the supply channel, but less space may be desired on the return channel, which would include just recirculation flux. Alternating cross-sectional sized channels (e.g., larger-smaller-larger-smaller) can accommodate such an example.

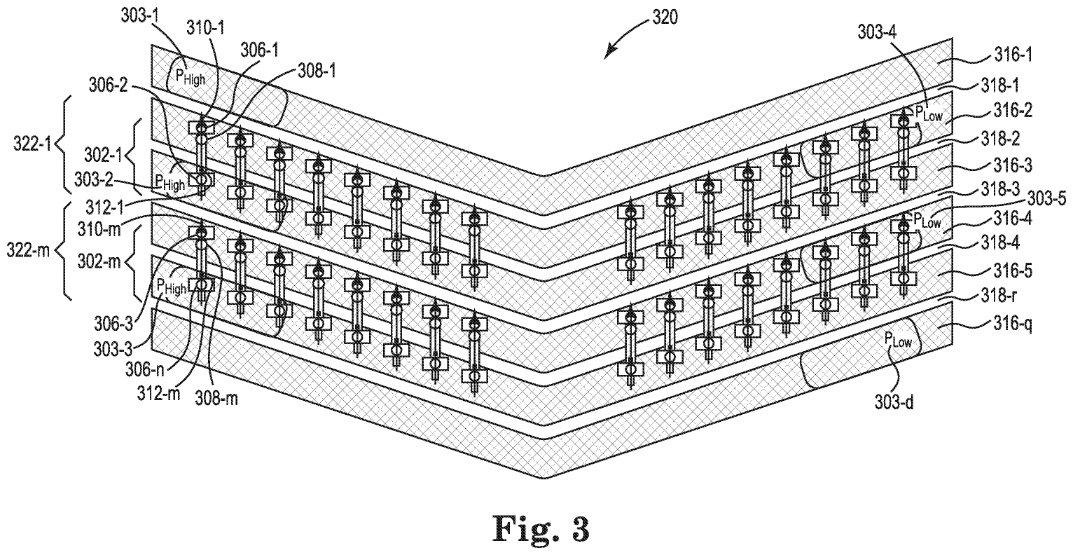

FIG. 3 is another diagram of an example recirculation fluid ejection device 320 including unit droplet generators 302, according to the present disclosure. The recirculation fluid ejection device 320 can have an increased number of channels as compared to other arrangements such that a fluid flow moves in the same direction across each rib 318 (e.g., a wall or divider that separates two channels) along which recirculation firing chambers are placed. For instance, recirculation fluid flow can move in the same direction across ribs 318 and recirculation firing chambers of the recirculation fluid ejection device 320, which can correspond to more similar pressures at the nozzles 308 and similar drop trajectories. This can reduce both alternating backpressures and flow directions along ribs 318, resulting in reduced print defects related to alternating fluid through chamber flow directions. The chevron pattern of the unit droplet generators 302 of recirculation fluid ejection device 320, as illustrated in FIG. 3, can blend fluid (e.g., droplet) trajectory issues that may occur improving print results.

The recirculation fluid ejection device 320 can include a first plurality 322-1 of unit droplet generators (e.g., an array of unit droplet generators) and a second plurality 322-m of unit droplet generators (e.g., an array of unit droplet generators). The first plurality 322-1 can include unit droplet generator 302-1, which includes a nozzle 308-1 between a fluid feed hole 306-1 located on the channel 316-2 and a fluid feed hole 306-2 located on the channel 316-3. In some instances, a pressure measurable at the inlet 303-2 of the channel 316-3 is different from a pressure measurable at the outlet 303-4 of the channel 316-2, which may indicate a pressure gradient.

In some examples, the unit droplet generator 302-1 can include a pump 312-1 for moving fluid through the unit droplet generator 302-1. For instance, the pump 312-1 can move fluid from an area having higher pressure (e.g., the channel 316-3) to an area of lower pressure (e.g., the channel 316-2) as indicated by the arrow 310-1. In some examples, the pump can move fluid from an area having lower pressure to an area having higher pressure (e.g., pressure gradients can be changed). For example, fluid can enter the channels 216 at one of the channel inlets/outlets 303-1, . . . , 303-d (e.g., labeled P_{High} and P_{Low}), and flow across all sixteen unit droplet generators 302 illustrated in FIG. 3. In addition to the unit droplet generator 302-1, the first plurality 322-1 can include unit droplet generators analogous to unit droplet generator 302-1.

The second plurality 322-m can include unit droplet generator 302-m, which includes a nozzle 308-m between a fluid feed hole 306-3 located on the channel 316-4 and a fluid feed hole 306-n located on the channel 316-5. In some instances, a pressure measurable at the inlet 303-3 of the channel 316-5 is different from a pressure measurable at the outlet 303-5 of the channel 316-4. This may indicate a pressure gradient.

In some examples, the unit droplet generator 302-m can include a pump 312-m for moving fluid through the unit droplet generator 302-m. For instance, the pump 312-m can move fluid from an area having higher pressure (e.g., the channel 316-5) to an area of lower pressure (e.g., the channel 316-4) as indicated by the arrow 310-m. In some examples, the pump can move fluid from an area having lower pressure to an area having higher pressure (e.g., pressure gradients can be changed). In addition to the unit droplet generator 302-m, the second plurality 322-m can include unit droplet generators analogous to unit droplet generator 302-m.

The channels 316-1, 316-2, . . . , 316-q can be separated by ribs 318, with the first plurality 322-1 and the second plurality 322-m being separated by a rib 318-3 of the recirculation fluid ejection device 320. The channels 316 can have different pressures. For instance, channels 316-1, 316-3, and 316-5 can have higher pressures than channels 316-2, 316-4, and 316-q. Rib 318-2 can separate fluid feed holes 306-1 (e.g., on the channel 316-2) of the first plurality 322-1 from fluid feed holes 306-2 (e.g., on the channel 316-3) of the first plurality 322-1 and rib 318-4 can separate fluid feed holes 306-3 (e.g., on the channel 316-4) of the second plurality 322-m from fluid feed holes 306-4 (e.g., on the channel 316-5) of the second plurality 322-m, in some instances.

The channels 316, in some examples, can have alternating cross-sectional areas (e.g., larger-smaller-larger-smaller, etc.). For instance, the larger cross-sectional area can accommodate higher pressure levels as compared to a channel having a smaller cross-sectional area, and/or fluids having a higher viscosity can create higher pressure drops through the channels 304, the larger cross-sectional area can accommodate desired flow rates. For instance, a supply channel can have a larger cross-sectional area than a return channel. In a high flux example, a larger amount of recirculation flux may be used as compared to a lower flux print job. In such an example, an increased amount of space may be desired to accommodate the recirculation flux plus the printing flux flowing to nozzles on the supply channel, but less space may be desired on the return channel, which would include just recirculation flux. Alternating cross-sectional sized channels can accommodate such an example.

In some examples, actuators (not visible in the view illustrated in FIG. 3) of the first plurality 322-1 and the second plurality 322-m eject fluid from the nozzles of the first plurality 322-1 and the second plurality 322-m, respectively, at substantially the same backpressure to recirculate fluid through an array of chambers across channel 316-2 and 316-4 and/or other channels of the recirculation fluid ejection device 320. For instance, adjacent channels have different backpressures that provide a pressure differential for fluid flow across a firing chamber and nozzles 308. Since the nozzles 308 are placed in the same orientation on the ribs 318, the fluid ejection backpressure at the nozzles 308 may be similar because they are symmetrically placed for parallel flow. Such an example recirculation may allow for recirculation of fluid through nozzles 308 of the first plurality 322-1 and the second plurality 322-m.

In the example illustrated in FIG. 3, fluid flow from each pump 312-1 of the first plurality 322-1 to each nozzle 308-1 of the first plurality 322-1 and fluid flow from each pump 312-m of the second plurality 322-m to each nozzle 308-m of the second plurality 322-m is unidirectional across the ribs 318-2 and 318-3. For instance, arrows 310 associated with the fluid flow in each of the first and the second pluralities 322 are pointed in the same direction and the actuators are ejecting fluid from nozzles 308 at substantially the same backpressure. In some examples, recirculation fluid ejection device 320 can reduce alternating rib backpressures and flow directions.

FIG. 4 is a diagram of an example recirculation fluid ejection device 450 having manifolded unit droplet generators 402 according to the present disclosure. The unit droplet generators 402-1 and 402-m can be analogous to the unit droplet generators 102, 202, 302, and/or 302 of FIGS. 1, 2, 3, and 4, respectively. In the example illustrated in FIG. 4, the unit droplet generators 402 are arranged in a manner analogous to those in FIG. 3, but arrangement of the unit droplet generators 402 are not so limited. The unit droplet generators 402 can be manifolded, as illustrated at 414-1, 414-2, . . . , 414-n. Manifolded unit droplet generators, as used herein, can include unit droplet generators that are coupled fluidically in a firing chamber layer (e.g., a fluidic layer that defines the fluid path between an actuator and a layer that defines a nozzle) such that they may not be individual units. For instance, non-manifolded unit droplet generators may have individual feed hold inlets and outlets for each nozzle/firing chamber unit, whereas manifolded droplet generators share with neighboring nozzles multiple (e.g., fluidically coupled) inlets and outlets in the firing chamber layer. As used herein, the term “unit droplet generator” is not limited to individual unit-like droplet generators, but can include fluidically coupled droplet generators (e.g., manifolded), among other architectures.

FIG. 5 is a diagram of an example recirculation fluid ejection device 560 including an asymmetrical unit droplet generator arrangement according to the present disclosure. The recirculation fluid ejection device 560 can include staggered channels 504 and can include a flipped asymmetrical pumping architecture such that some fluid feed holes of the unit droplet generators 502 can be located on a same channel but pump fluid in opposite directions, while still maintaining substantially consistent backpressures at which actuators (not visible in the view illustrated in FIG. 5) can eject fluid from the nozzles 508. In some examples, the asymmetrical unit droplet generator arrangement can be flipped every other rib 518 such that the recirculation flow direction is from pump 512 to nozzle 508 for each unit droplet generator 502. This direction can be reversed in some examples. The recirculation fluid ejection device 560 can include a chevron arrangement of the unit droplet generators 502, illustrated in FIG. 5, which can blend droplet trajectory issues that may occur.

The recirculation fluid ejection device 560 can include a unit droplet generator 502-1 spanning a rib 518-3 of the recirculation fluid ejection device 560 that includes an actuator (e.g., an actuator such as actuator 107 illustrated in FIGS. 1B and 1C) and a nozzle 508-1 between a fluid feed hole 506-1 located on a channel 504-3 having a particular pressure and a fluid feed hole 506-2 located on a channel 504-4 having a particular pressure. In some examples, the unit droplet generator 502-1 can include a pump 512-1 located on the channel 504-4 to move fluid (e.g., in the direction indicated by arrow 510-1) through the unit droplet generator 502-1. In some instances, a pressure measurable at the inlet 503-2 of the channel 504-4 is different from a pressure measurable at the outlet 503-3 of the channel 504-3, which may indicate a pressure gradient.

In some examples, the recirculation fluid ejection device 560 can also include a unit droplet generator 502-2 spanning a rib 518-4 of the recirculation fluid ejection device that includes an actuator (e.g., an actuator such as actuator 107 illustrated in FIGS. 1B and 1C) and a nozzle 508-2 between a fluid feed hole 506-3 located on a channel 504-4 having a particular pressure and a fluid feed hole 506-4 located on the channel 504-s. In some examples, the unit droplet generator 502-1 can include a pump 512-2 located on the channel 504-4 to move fluid (e.g., in the direction indicated by arrow 510-2) through the unit droplet generator 502-2. In some instances, a pressure measurable at the inlet 503-2 of the channel 504-4 is different from a pressure measurable at the outlet 503-d of the channel 504-5, which may indicate a pressure gradient. Similar, a pressure measurable at the inlet 503-1 may be different than associated outlets, for instance outlet 503-3.

The actuators can eject fluid from the nozzles 508 at substantially the same backpressure to recirculate fluid through the channels 504-3 and 504-s (and in some instances, other channels). In some examples, to eject fluid at the same backpressure, fluid moves from the pumps 512 towards the nozzles 508 in a same direction. For instance, the fluid can be pumped from a higher-pressure channel (e.g., the channel 504-4) to lower-pressure channels (e.g., the channels 504-3, 504-s) as indicated by the arrows 510. In some examples, the fluid movement may be from a lower-pressure channel to a higher-pressure channel. While nozzles 508-1 and 508-2 are discussed herein, as illustrated in FIG. 5, the recirculation fluid ejection device 560 can include additional nozzles operating at the same backpressure and arranged in a chevron pattern.

In some examples, the channel 504-3 can have a larger cross-sectional area than the channel 504-4. For instance, the larger cross-sectional area may accommodate a plurality of fluid feed holes of a plurality of unit droplet generators, such as fluid feed holes 506-2 and 506-3 of the unit droplet generators 502-1 and 502-2, respectively. Additionally or alternatively, the larger cross-sectional area can accommodate higher pressure levels as compared to a channel having a smaller cross-sectional area.

In some examples, fluids having a higher viscosity can create higher pressure drops through the channels 504, the larger cross-sectional area can accommodate desired flow rates. For instance, a supply channel supplying fluid to the nozzles 508 can have a larger cross-sectional area than a return channel taking fluid away from the nozzles 508. In a high flux example, a larger amount of recirculation flux may be used as compared to a lower flux print job. In such an example, an increased amount of space may be desired to accommodate the recirculation flux plus the printing flux flowing to nozzles on the supply channel, but less space may be desired on the return channel, which would include just recirculation flux. Alternating cross-sectional sized channels can accommodate such an example.

In the example illustrated in FIG. 5, fluid flow from the pump 512-1 to the nozzle 508-1 across the rib 518-3 is in a different direction than fluid flow from the pump 512-2 to the nozzle 508-2 across the rib 518-4 even though the fluid is moved from high to low pressure across the ribs 518-3, 518-4 (e.g., the nozzles operate at the same backpressure). The pumps 512 can include, for instance, micro inertial pumps.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A recirculation fluid ejection device, comprising:
a first unit droplet generator comprising a first actuator and a first nozzle between a first and a second fluid feed hole, the first fluid feed hole located on a first channel and the second fluid feed hole and a first pump located on a second channel; and
a second unit droplet generator comprising a second actuator and a second nozzle between a third and a fourth fluid feed hole, the third feed hole located on a third channel having the first pressure and the fourth fluid feed hole and a second pump located on a fourth channel having the second pressure,
wherein the first and the second actuators eject fluid from the first and the second nozzles at substantially the same backpressure to recirculate fluid through the first and the third channels and the first nozzle and the second nozzle, and
wherein a first pressure measurable at an inlet of the first channel and the third channel is different from a second pressure measurable at an outlet of the second channel and the fourth channel.

2. The recirculation fluid ejection device of claim 1, wherein:
the first nozzle is located nearer the first fluid feed hole than the second fluid feed hole; and
the first pressure is a lower pressure than the second pressure.

3. The recirculation fluid ejection device of claim 2, wherein the second channel has a larger cross-sectional area than the first channel.

4. The recirculation fluid ejection device of claim 1, wherein:
the first nozzle is located nearer the first fluid feed hole than the second fluid feed hole; and
the first pressure is a higher pressure than the second pressure.

5. The recirculation fluid ejection device of claim 1, wherein the recirculation fluid ejection device receives a command to adjust the first and the second pressures.

6. A recirculation fluid ejection device comprising:
a first plurality of unit droplet generators, each one comprising an actuator and a nozzle between a first fluid feed hold on a first channel having a first pressure and second fluid feed hole on a second channel having a second pressure;
a second plurality of unit droplet generators separated from the first plurality of unit droplet generators by a first rib in the recirculation fluid ejection device, wherein each one of the second plurality of unit droplet generators comprises an actuator and a nozzle between a third fluid feed hole on a third channel having a third pressure and a fourth fluid feed hole on fourth channel having a fourth pressure;
a fifth channel having a fifth pressure and separated from the first channel by a second rib in the recirculation fluid ejection device; and
a sixth channel having a sixth pressure and separated from the fourth channel by a third rib in the recirculation fluid ejection device,
wherein each one of the actuators of the first plurality of unit droplet generators and each one of the actuators of the second plurality of unit droplet generators ejects fluid from each one of the nozzles of the first plurality of unit droplet generators and each one of the nozzles of the second plurality of unit droplet generators, respectively, at substantially the same backpressure to recirculate fluid through an array of chambers across the first and the third channels to recirculate fluid through each one of the nozzles of the first plurality of unit droplet generators and each one of the nozzles of the second plurality of unit droplet generators.

7. The recirculation fluid ejection device of claim 6, further comprising:
a fourth rib in the recirculation fluid ejection device separating the first fluid feed holes on the first channels from the second fluid feed holes on the second channel; and
a fifth rib in the recirculation fluid ejection device separating the third fluid feed holes on the third channel from the fourth fluid feed holes on the fourth channel.

8. The recirculation fluid ejection device of claim 6, further comprising:
the first plurality of unit droplet generators each comprising a pump located on the second channel; and
the second plurality of unit droplet generators each comprising a pump located on the fourth channel.

9. The recirculation fluid ejection device of claim 8, wherein fluid flow from each pump of the first plurality of unit droplet generators to each nozzle of the first plurality of unit droplet generators and fluid flow from each pump of the second plurality of unit droplet generators to each nozzle of the second plurality of unit droplet generators is unidirectional across the first and third ribs.

10. The recirculation fluid ejection device of claim 6, wherein the first, the second, the third, and the fourth channels comprise alternating cross-sectional areas.

11. A recirculation fluid ejection device comprising:
a first unit droplet generator spanning a first rib of the recirculation fluid ejection device, comprising:
a first actuator;
a first nozzle between a first fluid feed hole located on a first channel having a first pressure and a second fluid feed hole located on a second channel having a second pressure; and
a first pump located on the second channel; and
a second unit droplet generator spanning a second rib of the recirculation fluid ejection device, comprising:
a second actuator;
a second nozzle between a third fluid feed hole located on a third channel having a third pressure and a second fluid feed hole located on the second channel; and
a second pump located on the second channel,
wherein the first actuator and the second actuator eject fluid from the first and the second nozzles, respectively, at substantially the same backpressure to recirculate fluid through the first channel and the third channel and through the first nozzle and the second nozzle; and
wherein fluid flow from each one of the first pumps to each of the first nozzles across the first rib is in a different direction than fluid flow from each of the second pumps to each of the second nozzles across the second rib.

12. The recirculation fluid ejection device of claim 11, wherein:
the first channel has a smaller cross-sectional area than the second channel; and
the third channel has a smaller cross-sectional area than the second channel.

13. The recirculation fluid ejection device of claim 12, wherein:
the second channel is a supply channel to supply fluid to the first and the second nozzles; and
the first and the third channels are return channels to take fluid away from the first and the second nozzles.

14. The recirculation fluid ejection device of claim 11, further comprising a plurality of additional nozzles and additional actuators arranged in a chevron pattern,
wherein the additional actuators eject fluid from the additional nozzles at substantially the same backpressure as the first and the second actuators.

15. The recirculation fluid ejection device of claim 11, wherein each one of the first pumps and each one of the second pumps is a micro inertial pump.
